(19) United States
(12) Patent Application Publication
(10) Pub. No.: US 2005/0188943 A1
(43) Pub. Date: Sep. 1, 2005

(54) System and method for customizing a rotary engine for marine vessel propulsion

(76) Inventors: Henry Gonzalez, Miami Lakes, FL (US); Rodolfo Alonso, Hialeah Gardens, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 11/043,548

(22) Filed: Jan. 26, 2005

Related U.S. Application Data
(63) Continuation-in-part of application No. 10/969,565, filed on Oct. 20, 2004.
(60) Provisional application No. 60/513,168, filed on Oct. 21, 2003.
(60) Provisional application No. 60/542,146, filed on Feb. 6, 2004.
(60) Provisional application No. 60/543,160, filed on Feb. 10, 2004.

(51) Int. Cl. F02B 53/00

(52) U.S. Cl. 123/245

(57) ABSTRACT

The invention relates to the adaptation of a Mazda RENESIS rotary engine to use as a marine vessel propulsion system. It is an object of present invention to enhance the power and torque bands of the rotary engine and shift them to the midrange of engine speeds that are most applicable in direct drive systems. Peak torque of 300 ft-lbs. at 3750 rpm and Peak power of 325 hp at 5800 rpm have been realized. The invention comprises various engineering developments to increase performance. These developments include modifications to standard engine components such as intake and exhaust manifolds as well as addition of customized performance tuned components including a turbocharger, an aftercooler, an oil cooler, and an engine control management system. Improvements to engine mounting and power transmission mechanisms are also described.

### CROSS-REFERENCE TO RELATED APPLICATIONS

This is a Continuation-In-Part Application of pending U.S. Non-Provisional application Ser. No. 10/969,565, filed Oct. 20, 2004, entitled SYSTEM AND METHOD FOR CUSTOMIZING A ROTARY ENGINE FOR MARINE VESSEL PROPULSION, and claims the benefit of U.S. Provisional Application Ser. No. 60/513,168, filed Oct. 21, 2003, entitled DESCRIPTION OF METHODOLOGY DEVELOPED TO MARINIZE THE WANKEL ROTARY ENGINE, U.S. Provisional Application Ser. No. 60/542,146, filed Feb. 6, 2004, entitled NATURALLY ASPIRATED ROTARY ENGINE HAVING AN OUTPUT BETWEEN 175 AND 250 HORSEPOWER FOR WATERCRAFT APPLICATIONS AND METHOD and Provisional Application Ser. No. 60/543,160, filed Feb. 10, 2004 entitled DESCRIPTION OF METHODOLOGY DEVELOPED TO MARINIZE THE WANKEL ROTARY ENGINE.

### SUMMARY OF THE INVENTION

The invention relates to the adaptation of a Mazda RENESIS rotary engine to a marine environment. It is an object of present invention to enhance the power and torque bands of the rotary engine and shift them to a range of engine speeds most applicable in direct drive systems such as those used in propulsion of a marine vessel. Peak torque of 300 ft-lbs. at 3750 rpm and Peak power of 325 hp at 5800 rpm have been realized.

The invention comprises various engineering developments to increase performance in the midrange engine speeds of 3700 to 6000 rpm. These developments include modifications to standard engine components such as intake and exhaust manifolds as well as addition of customized performance tuned components including a turbocharger, an aftercooler, an oil cooler, and an engine control management system.

The following description of preferred embodiments in conjunction with the drawings will serve as a more detailed explanation of the invention.

### BACKGROUND OF THE INVENTION

Rotary engine designs in one form or another have been reported earlier than reciprocating internal combustion engines have been used in automobiles. One of the most successful designs, the Wankel rotary, has an early history with the NSU company and later with Mazda Corporation. A new generation of Mazda rotary engines, the RENESIS engines, have recently been introduced with improvements to performance and emissions over earlier engine designs. While the design and function of the rotary engine is outside the scope of this disclosure, aspects of the invention as related to engine function and performance will be disclosed where appropriate.

Just as in the reciprocating piston internal combustion engine, the RENESIS rotary engine performs fuel intake, compression, ignition, and exhaust functions for each power cycle. The rotary engine uses a trochoid shaped chamber and a triangular shaped rotor to shape the combustion region, as shown in FIG. 1, while the reciprocating piston engine uses a piston and a cylindrical chamber to shape the combustion region. There are several advantages that the Wankel rotary engine has over the reciprocating engine for use in marine environments. First, the Wankel engine is physically smaller than a reciprocating engine of equal power output. It is estimated that a V-8 internal combustion reciprocating engine of horsepower similar to a Wankel engine would occupy about four times more engine compartment space. In small pleasure boats, for example, where space is restricted, this advantage is highly significant. The Wankel rotary engine also weighs much less than a V-8 reciprocating engine of comparable power. The Mazda engine weighs approximately 340 lbs. while the V-8 weighs about 800 lbs. This weight difference is important in terms of available passenger and cargo loading capacity as well as the negative effects of excess weight on performance and fuel consumption. Other advantages of the Wankel engine include reduced engine vibration, fewer moving parts to wear, and a high volumetric efficiency due to even fuel distribution as a result of the use of intake ports instead of intake valves. Finally, because there are three combustion chambers on each rotor, the Mazda rotary engine is capable of maintaining high crankshaft rpm rates, while rotor rpm is only one-third of that rate.

Conventional thinking held that rotary engines were not well suited for use in marine applications since they did not develop sufficient torque to be practical. Torque is a product of the length of a moment arm and the Force applied. In a reciprocating engine, the length of the moment arm is the distance that the piston travels within the cylinder on each power stoke, and is equal to the eccentricity of the crankshaft. In a rotary engine, the eccentricity of the crankshaft is one-half that of a piston engine, resulting in a smaller moment arm length. As a result of this disparity, to obtain equal torque, the force applied by the rotary engine must be doubled to compensate for the shorter moment arm length. It is therefore important to increase the power output from a rotary engine in order to obtain output torque in the range required for marine applications.

There are differences between the Application of the Mazda rotary engine in a marine environment and a terrestrial environment in several respects. The Mazda rotary engine, as delivered from the factory, attains peak horsepower at engine speeds at around 8500 rpm. This is fine for automotive applications where transmissions are commonly used, however, unlike automotive applications, it is often undesirable for small marine vessels to incorporate transmissions for the purpose of changing the ratio between engine speed and final drive speed. Adding a transmission would increase powerplant weight, space, and reduces power output due to friction on internal components. Under this constraint, it is desirable for the engine to attain peak torque and horsepower at lower engine speed as not to place undue strain on final drive components. The invention described herein, describes a system that provides a solution that matches rotary engine speed with requirements of driveline components for marine vessels without the use of a transmission.

Several companies have attempted to use Mazda rotary engines to power marine vessels. Rotary Marine Inc developed a 175 hp naturally aspirated version of the Mazda 13B rotary engine for use in power boats. Market pressures and poor performance led to company failure. Product rights were sold to Rotary Power International, which developed a supercharged rotary engine with electronic injection that achieved increased horsepower for marine applications. Power/price ratio was still unattractive and the company was sold to Rotary Power Marine Corporation. That company has been unable to design, test and deliver a rotary engine that delivers at least 300 hp.

### BRIEF DESCRIPTION OF THE DRAWINGS

FIG. 1 shows a cutaway diagram of the internal structure of a Mazda rotary engine.

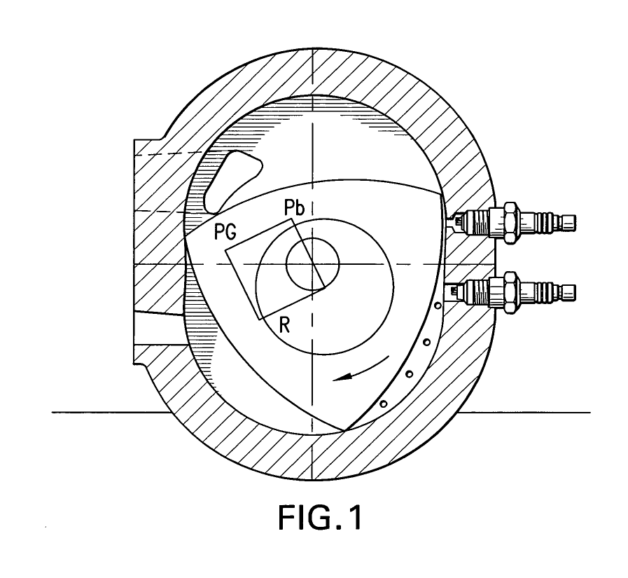

FIG. 2 is an exploded view, in block diagram form, of the first embodiment showing the engine core and performance tuned stock and auxiliary components.

FIG. 3 is a drawing of the turbocharger system with relevant components.

FIG. 4 is a representative curve for turbocharger boost versus RPM.

FIG. 5 is a drawing of the turbocharger housing.

FIG. 6 is a drawing of the Aftercooler design.

FIG. 7 is a drawing of the Aftercooler bracket.

FIG. 8 is a flow chart for the operation of the Engine Management System.

FIG. 9 details the cooling system as applied in the preferred embodiments.

FIG. 10 is a drawing of a single unit oil and engine coolant heat exchanger.

FIG. 11 is a diagram showing the torque and power response of the turbocharged engine at various engine speeds as recorded on a dynamometer.

FIG. 12 is a diagram showing the torque and power response of a non-turbocharged engine at various engine speeds as recorded on a dynamometer.

### DETAILED DESCRIPTION OF THE INVENTION

The present invention relates to the adaptation of a Mazda RENESIS rotary engine to a marine environment. The power and torque characteristics of the rotary engine are increased and shifted to a lower range of engine speeds most applicable in direct drive systems such as those used to propel a marine vessel.

The invention comprises various engineering developments specifically designed to increase performance at the desired rpm range. These developments include modifications to standard engine components such as intake and exhaust manifolds as well as addition of customized performance tuned components such as a turbocharger, an aftercooler, and an oil cooler. Since a combination of engineering changes and addition of components contribute in some part to the desired result of increased performance at lowered engine speed, each of these changes will be described herein. Where the inventor has made significant design and operational changes to a particular component, it shall be noted by the words “specifically engineered”.

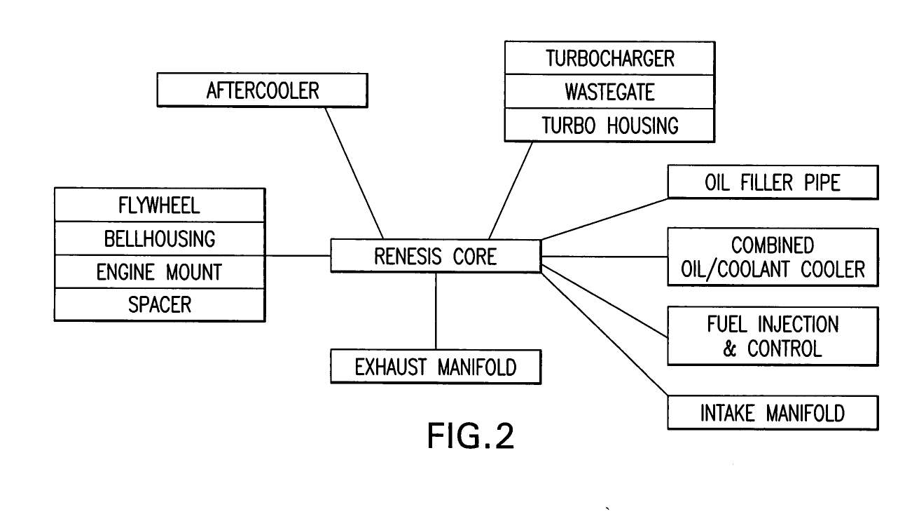

Direct drive of propeller systems in a marine vessel requires that propeller shaft speeds be maintained at lower engine speed to reduce component stresses. Concurrently, high torque and power is required to counteract drag generated by the hull as it pushes through the water. FIG. 2 is an exploded view, in block diagram form, of modified and added components in the system of the present invention.

Two embodiments of the engine system are described herein, an embodiment of a two rotor RENESIS engine using at least one turbocharger to boost torque and power, and an embodiment of the same engine without a turbocharger. In both cases, peak torque and power is maintained below 6000 rpm to minimize excess component stress. The midrange of engine speed (3700 to 6000 RPM) is most suitable for direct drive marine vessel propulsion.

In the first embodiment, a large part of the system performance enhancement comes from the cooling and compression of the intake charge, resulting in increased air/fuel mixture entering the combustion chamber. This increased air/fuel mixture allows enhanced combustion that results in increased power. An addition of a single, relatively large turbocharger to the system is responsible for this performance enhancement. A turbocharger is a component with two impellers operatively connected by a shaft. One impeller is placed in the path of the exhaust gases and the second impeller is placed in the path of the intake charge. Exhaust gases expelled from the engine pass through the exhaust side of the turbocharger, spinning the impeller in that section. In response, the impeller (or wheel) in the intake section of the turbocharger spins, compressing intake air that is supplied to the engine through the intake manifold. This compressed air permits an increased amount of fuel to be introduced, resulting in a power gain. Increased power and torque can be obtained from an engine by use of at least one turbocharger. While the use of turbochargers in Mazda rotary engines has been successfully achieved by Mazda in the past, peak power and torque was realized at engine speeds greater than about 8000 rpm. These high engine speeds are not appropriate for direct drive applications in a marine environment.

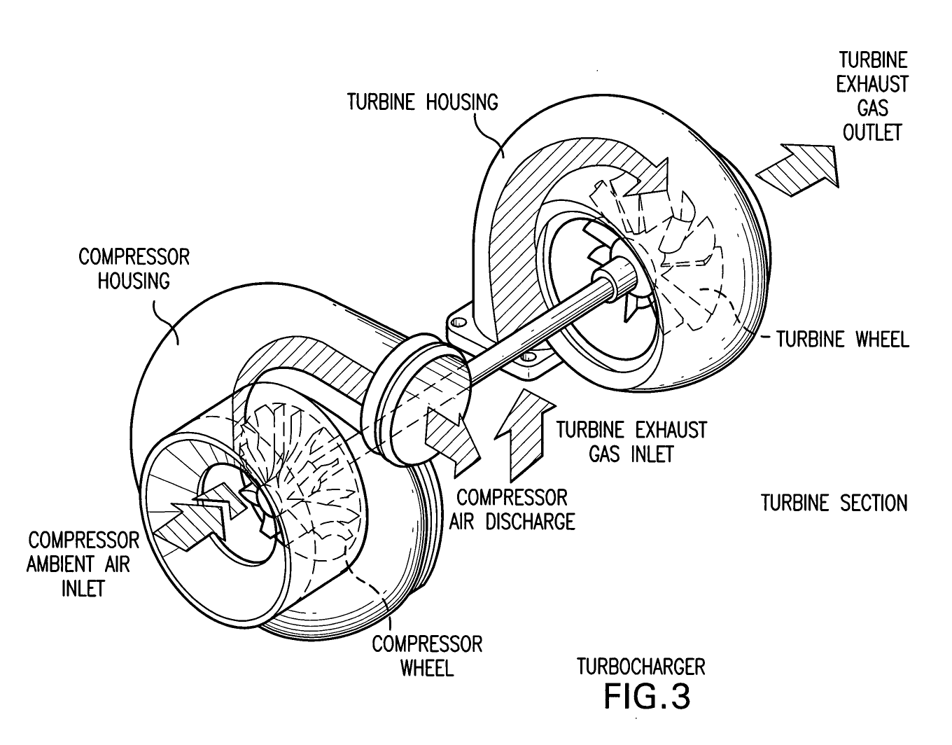

The design of the turbo housing, the turbine blades, and the relative fit of these components influences output power. FIG. 3 shows the various components that comprise the turbocharger system. Performance of the system is dependent upon the following factors:
1) The backpressure between the Exhaust port and the Turbine
2) The size of the Aftercooler
3) The turbine housing specifications
4) The turbine wheel specifications
5) The compressor housing specifications
6) The compressor wheel specifications
7) The wastegate position and dimensions
8) The air flow between the Throttle body and the Aftercooler
9) The boost pressure/RPM relationship

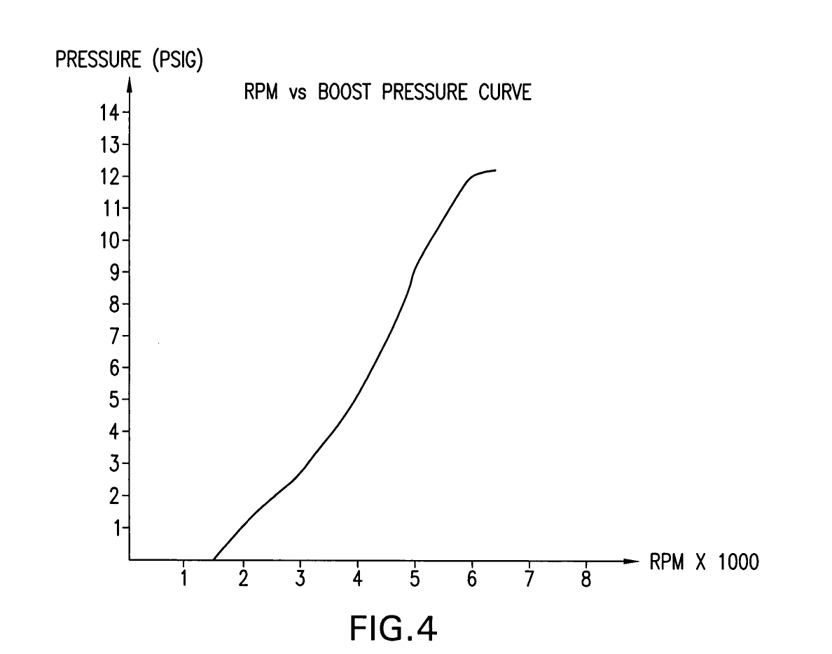

The ratio of exhaust pressure to intake pressure, or backpressure, must be maintained between 1:1 and 2:1 to obtain a 0-14 psi boost in a marine environment. By law, exhaust gasses must be passed through water, further restricting flow of gases, requiring increased exhaust pressure to maintain boost pressure in the desired range. In this embodiment, the turbocharger housing is a stainless steel design with impeller blades specifically engineered to minimize backpressure and maximize compression and is fitted with an internal waste-gate. The turbine wheel is a stage V, 10 or 11 blade P-trim design, with an exducer diameter of 2.437 inches and a major diameter of 2.795 inches. The gap between the turbine housing and turbine wheel influences the backpressure as well. As the gap decreases, backpressure increases since exhaust flow is restricted. The angle of the impeller blades also influence backpressure, as the backpressure increases with the relative angle. Also as the number of blades increases, the backpressure increases, due to resistance of air flow. As a result of these relationships, impellers and housings are carefully matched using engine dynamometer readings. The waste-gate is specifically engineered to permit excess pressure to be relieved, as not to allow more boost than the engine can handle. The wastegate has also been designed to reduce resistance to airflow and its relocation next to the flange helps manage boost control because of reduced air turbulence, and decreased static pressure at this location. The dimension of the wastegate is between 1 and 1½ inches. This is 1.5 times larger than what would be required for a turbocharger on a piston engine of similar performance. Also, a 2:1 ratio of exhaust to intake boost pressure is maintained to reduce turbo lag, which is defined by the time required for the exhaust gas flow to be high enough as to cause a noticeable surge of power due to turbocharger operation. FIG. 4 shows a representative graph of Boost Pressure versus RPM for a turbocharged engine. Intake boost begins at about 2000 RPM and quickly ramps up to about 6300 RPM. The wastegate operates to reduce boost by bleeding exhaust gases off, thereby maintaining a linear relationship between boost pressure and engine speed at RPMs above about 5000.

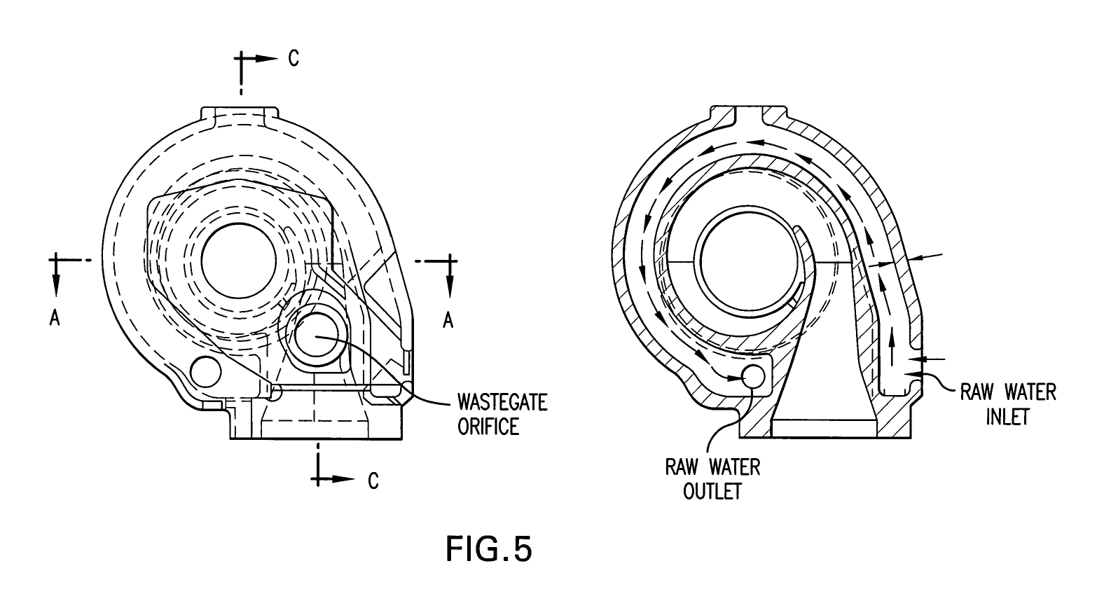

Passageways in the turbocharger housing circulate cooling water to the unit to keep the bearings cool and help cool the exhaust and intake gases, as shown in FIG. 5. The exhaust side of the turbo housing has been specifically engineered to be mated to the exhaust manifold at a position equidistant from the dual exhaust ports on the engine housing. This configuration increases the volume of exhaust gases passing through the exhaust side of the turbocharger. A similar configuration was used on turbocharged models of earlier Mazda rotary engine designs, however the exhaust manifolds of. RENESIS engines received from Mazda factories do not use this design and older model exhaust manifolds do not fit the newer RENESIS engine.

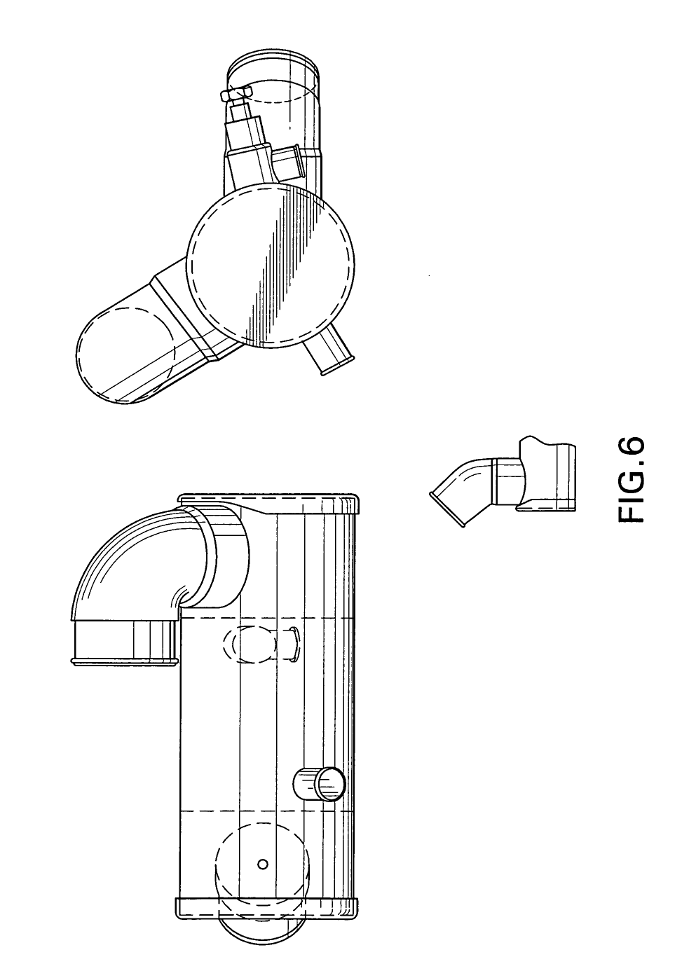

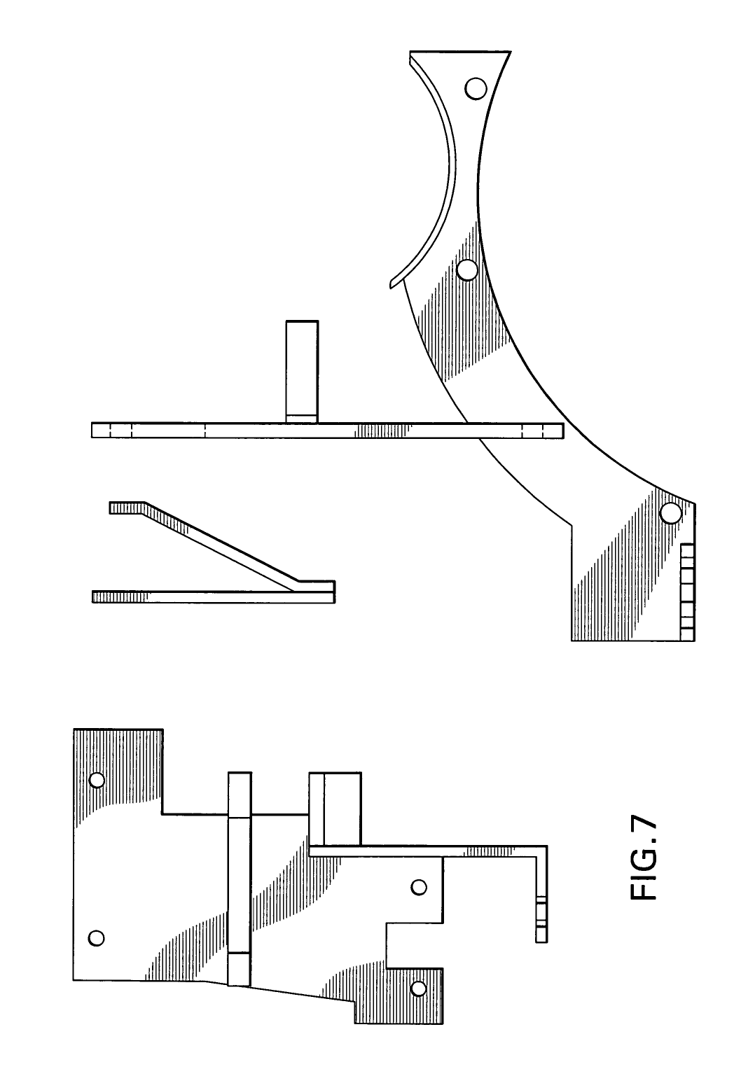

As the turbocharger compresses the air to be introduced into the intake manifold, the temperature of the gases rise. The hot gas expands, reducing its density. To counteract this effect, the air can be cooled whereby its density is increased, increasing the amount of air that can be introduced into the engine. As the density of the air increases, so does the amount of fuel that can be supplied, producing increased power. As shown in FIG. 6, an aftercooler (or intercooler) is provided that cools the intake gases. The aftercooler, specifically engineered for the RENESIS engine is unusual because it has a honeycomb internal structure, where cooling water is circulated inside the honeycomb itself, while the warm, pressurized air is circulated around the honeycomb pattern, in contact with its large surface area. This is the reverse of the usual arrangement for these types of aftercoolers. Resistance to airflow is less than 1 pound per square inch (psi), and supports a flow of 1000 to 2500 cubic feet per minute (cfm), which is 1.5 to 2 times the capacity typically recommended for an engine the size of the Mazda RENESIS engine. The Intercooler size required for this invention has been empirically determined to be between 1.25 and 1.7 times the size needed for a design used on a piston engine. This is because the area of the aftercooler must be increased to decrease the velocity of the intake charge and maintain constant intake air flow. Cooling water flow within the aftercooler is in the range of 35 to 40 gallons per minute (gpm). When the cooling water system is of the open, non-recirculation type, a stainless steel aftercooler is used. In some temperate latitudes, cooling water supplied by the marine environment has the advantage of relatively constant intake water temperature. Other embodiments of this invention may use a closed coolant recirculation system with added components such as cooling fans, radiators, thermostats, and freeze/boil resistant fluids. In fitting the aftercooler to the RENESIS engine, a special Intercooler/fuel pump bracket was specifically engineered and positioned to promote nonrestrictive airflow in the throttle-body tubing. FIG. 7 is a drawing of this bracket. As a result, the airflow through the throttle body maintains a range of 0 to 850 cfm.

In addition to the aftercooler for cooling the intake charge, the exhaust gases are also cooled before they enter the exhaust side of the turbocharger housing. As mandated by safety considerations, cooling water flows through the exhaust manifold housing to cool the exhaust gases as they exit the engine exhaust ports. Cooling of the exhaust gases does result in decreased thermal energy, as some of the energy is transferred to the cooling water. Turbo housing and impeller sizing and configuration are specifically engineered to offset this loss.

In addition to increased air density, increased intake air volume is supported by specifically engineered intake manifold runners. The inside diameter of the runners fall in the range of 1.2 to 2.4 inches and the curvature of the runners follow an angle of about 90 degrees over a radius of about 3 inches. The resulting airflow supported is 0 to 850 cubic feet per minute (cfm). The location and number of the fuel injectors within the intake manifold has also been specifically engineered to optimize quantity and atomization of injected fuel. It has been empirically determined that injector placement at factory specified locations, close to the intake ports result in quick acceleration response. Primary injector capacity has been increased from the factory setting of 370 cc to 520 cc. Also, the primary injector timing ranges from 420 degrees at idle to 280 degrees at 6300 RPM relative to intake port timing. Secondary injector placement has been moved to the intake manifold runners in order to improve atomization of fuel mixture in higher air volumes in order to produce larger engine output power. They have been moved to a distance of 7 to 12 inches from the intake port plate. Secondary injection timing has been modified to occur at 200 to 342 degrees from intake port timing. This occurs throughout the range from 1000 to 6300 RPM.

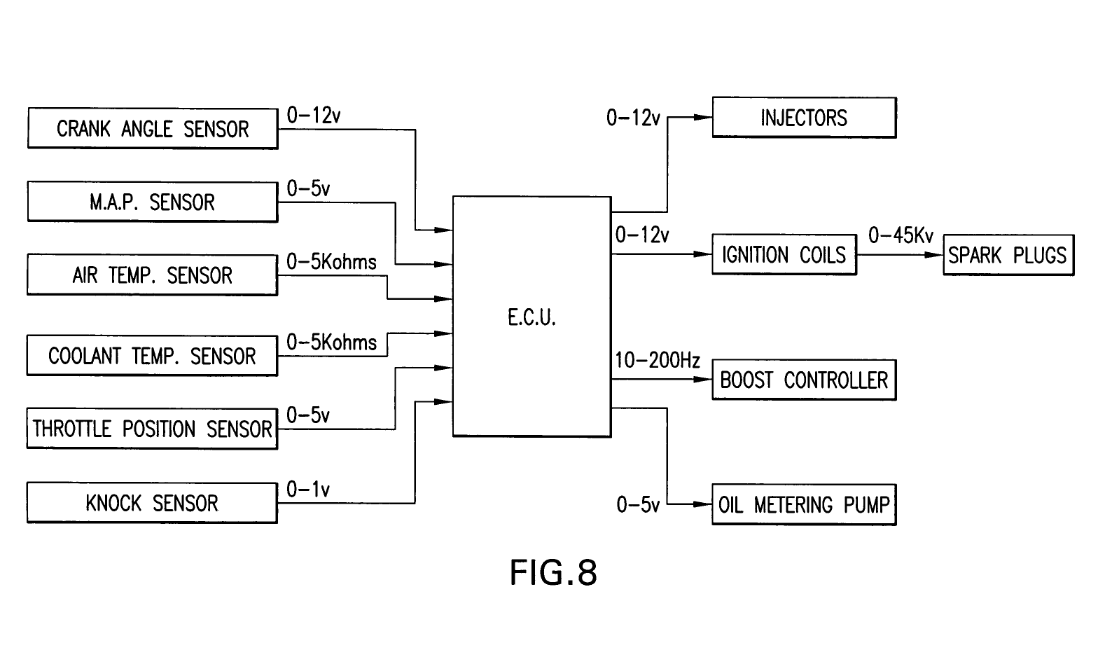

Each of the components described above contribute to the increase in overall system performance by executing some function either continuously or within a tightly regulated time frame. Fuel delivery, for example must be metered and coordinated with the air volume and flow rate. These types of synchronization and timing events are regulated by a computer controlled engine management system (ECU). Measurements such as engine speed, intake and exhaust manifold pressure, and air and water temperature, are recorded by various sensors. The values function as operands to be used in calculating spark timing, coil dwell, fuel injection pulse start and dwell time, and oil injection pump control timing by the electronic control unit. FIG. 8 presents a flow diagram outlining the sequence of steps performed by the electronic engine management system in the present invention. The resulting map of measurements and data points are used by the electronic engine management system to actuate system components to function in a desired manner. In the disclosed system, turbocharger boost pressure, injector and ignition timing are also monitored and controlled every 150 rpm. A air to fuel mixture ratio of 13.1:1 to 13.8:1 are maintained at all times. Ignition,timing is controlled within the following range:
Leading spark range: 5 degrees Before Top Dead Center (BTDC) to 18 Degrees BTDC Trailing spark range: 5 degrees After TDC to 3 degrees BTDC

It is well known in the art that turbocharged engines are susceptible to detonation and pre-ignition due to boost pressure and require changes to the spark timing and fuel use to combat these effects. Retarding the spark timing helps combat detonation. Detonation is defined as a combustion process wherein energy release is too rapid, resulting in excessive pressures and temperatures. It results in a turbocharged engine because higher boost pressure cause an increased rate of flame advance in the compression chamber. Retarding the spark timing will allow a more complete burn of the. fuel prior to exhaust. Ignition retard is typically applied at engine speeds where boost pressures, and maximum torque, are most evident. In the present invention, this range of engine speeds is between 3500 RPM and 5700 RPM.

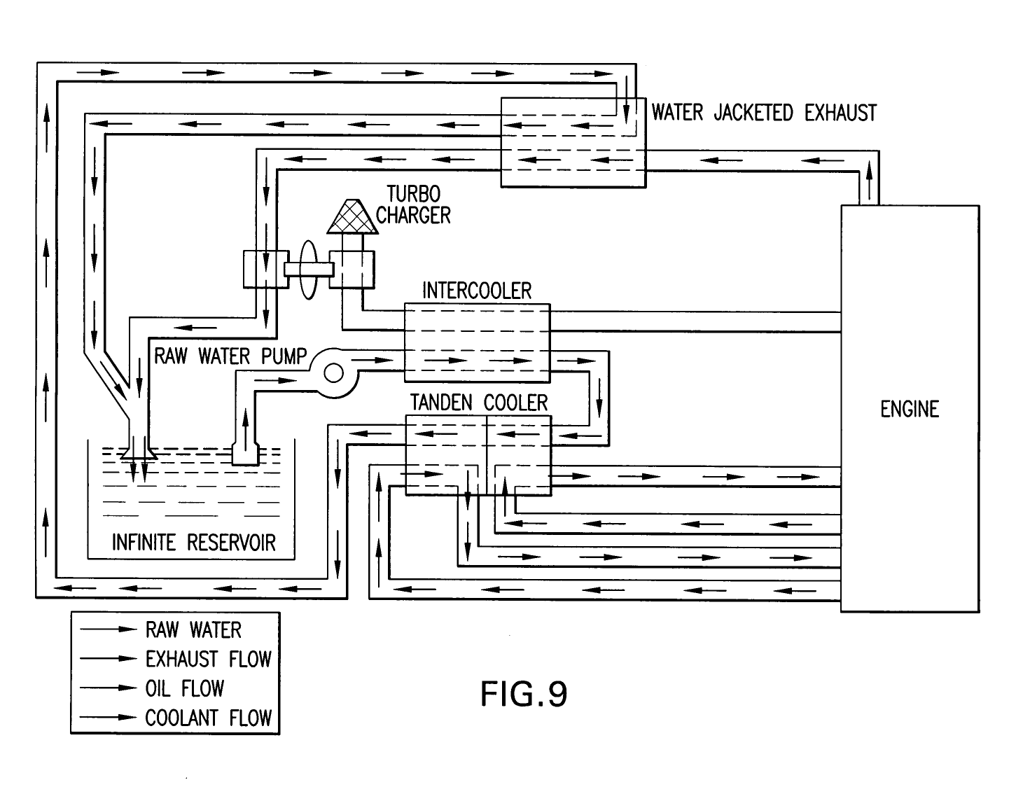

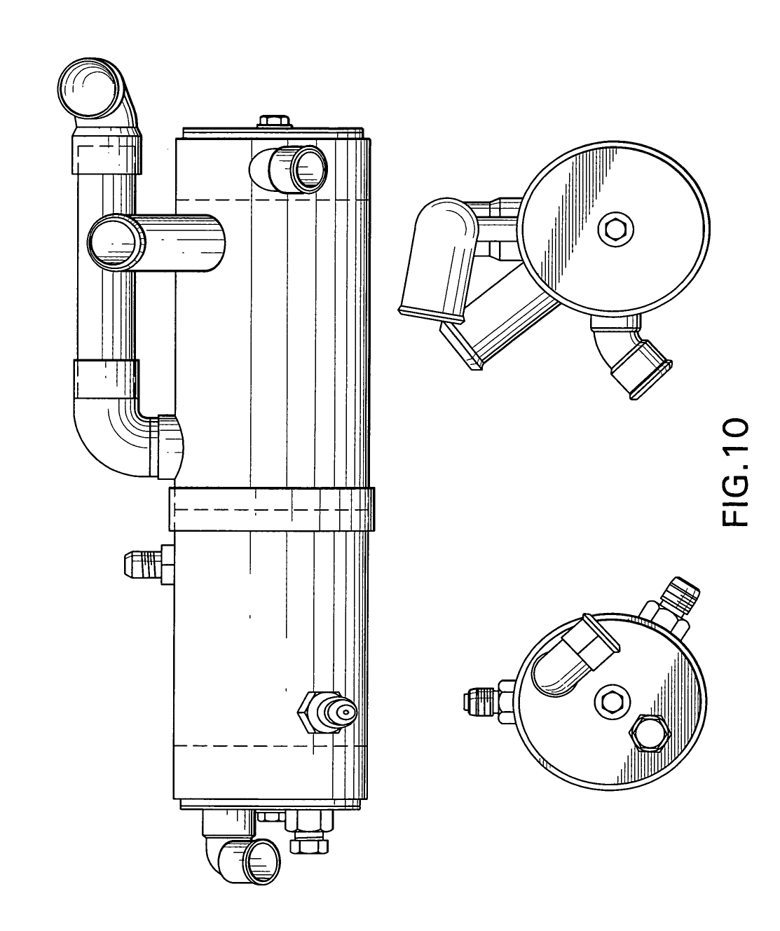

The rotary engine and associated engine components are cooled using a liquid flow system. The system can either be closed (recirculated) or open (non-recirculated) as needed. For the embodiments described herein, the system as shown in FIG. 9 is a combination of the two types. A single unit water-cooled engine oil and engine coolant heat exchanger (Tandam cooler) has also been specifically engineered for the present invention. Non-recirculated water is pumped through the turbocharger, the intercooler, the Tandam cooler, and the exhaust manifold before exiting the system. Note that the water is first pumped through the Aftercooler, allowing this compressed air heat exchanger to receive the coolest water. Non-recirculated water is not sent to the engine. Instead, the engine is cooled with recirculated coolant, while the coolant is cooled with the non-recirculated water. Recirculated engine oil is also cooled through the same Tandam cooler. Water flow through the unit is specified in a range from 0 to 34 gallons per minute. The single unit design, shown in FIG. 10, offers a space saving advantage.

Other improvements include an engine mount that has been specifically engineered to permit adjustment in the vertical and horizontal planes to facilitate mounting in a boat hull and to help counteract torque produced by the engine. The flywheel on the stock RENESIS engine has been exchanged with a specifically engineered flywheel that has an increased weight by about 20% to 35% to reduce engine stresses, while still allowing the engine to have sufficient momentum for low speed operation under changing load conditions. Bolt holes have been drilled to permit mating to a spacer that in turn is fitted onto the propeller final drive assembly. Other engine modifications include a water resistant starter motor and mounting bracket and a bell housing specifically engineered to permit mounting the starter motor in a position that is perpendicular to the longitudinal axis of the engine.

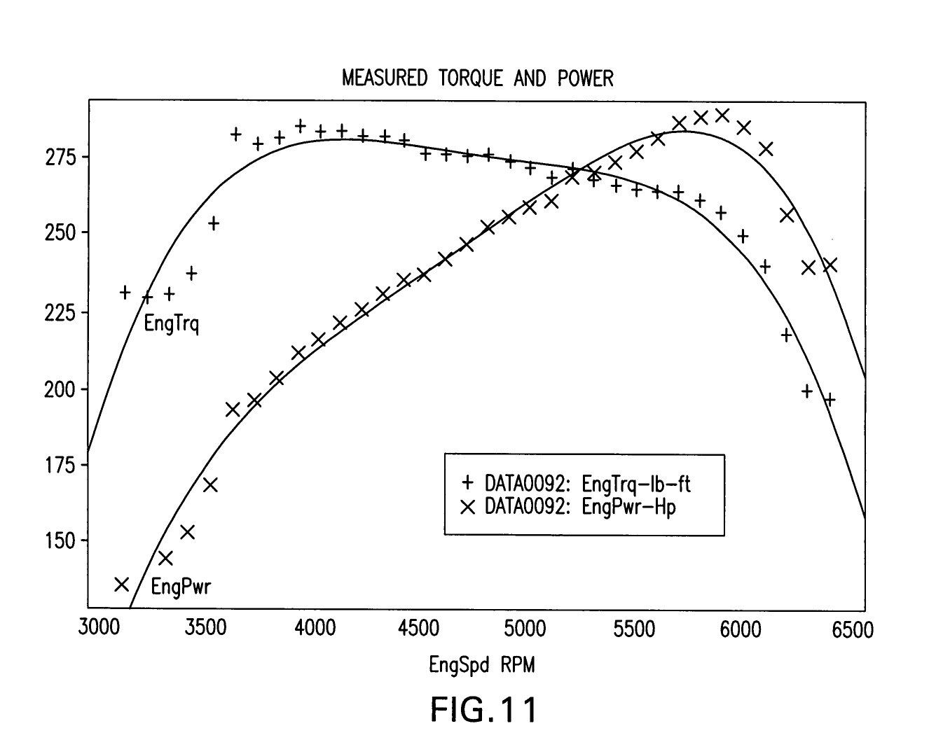

As a result of the above mentioned engineering modifications, the peak power from the first embodiment of this invention is demonstrated to be approximately 325 hp at about 5800 rpm, while the torque curve remains relatively flat at around 300 ft-lbs. from 3750 rpm to 5500 rpm, as shown in FIG. 11. The horsepower curve in the figure is derived from the torque readings and represents what is called the “Brake HP”, which indicates the resulting power available after losses from engine components. Brake HP is calculated as follows:
Brake HP=(2*□.*Torque*Engine Speed)/33000
where torque is expressed in foot-pounds (ft.-lbs), engine speed is expressed in revolutions per minute (rpm), and one horsepower is equal to 33000 ft-lbs. per minute.

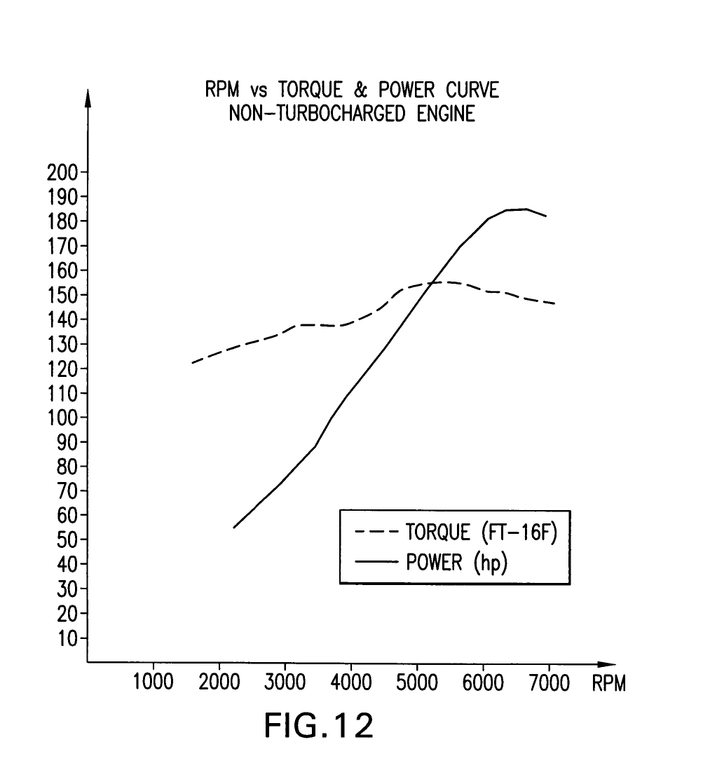

A second embodiment of the present invention shifts the peak power and torque response of the Mazda RENESIS engine to engine speeds suitable for use in a marine environment without use of a turbocharger and aftercooler system. In this situation, various adjustments to the fuel and spark management system are needed. Variations in the parameters as outlined in the first embodiment are as follows. Both the boost sensor and boost controller are not needed, so parameters concerning boost are removed from the management system. In the non-turbocharged engine management system, both injection and ignition timing are controlled by engine RPM, intake vacuum and throttle body position. Both leading and trailing ignition timing is controlled at 5 degrees to 32 degrees BTDC between 1000 RPM and 6300 RPM. Air:fuel mixture is maintained between 13.1:1 and 14.1:1 from 1000 RPM to 6300 RPM. Both ignition timing and air:fuel mixture differs somewhat from the turbocharged version of the RENESIS engine in order to sustain desired performance objectives. A representative power and torque curve for such an engine is shown in FIG. 12.

In addition to modifications to the engine, design changes in the driveline support use of the Mazda RENESIS engine for marine vessel use. A spacer used for attaching the propeller shaft to the flywheel has been specifically engineered to be thin (approximately 3 1/7 inches thick) as to reduce the distance between the engine and the propeller drive. This accomplishment is partially due to the perpendicular mounting of the starter motor, permitting use of a somewhat shorter bell-housing than what would otherwise be needed in this application.

Additional embodiments of the present invention include use of multiple turbochargers to handle multiple RPM ranges, one or more superchargers in lieu of a single turbocharger,. addition or changes within the fuel and spark delivery systems, and addition of a transmission system or other conversion system that changes the final drive ratio.

Although the invention has been described in connection with various specific embodiments thereof, it should be appreciated that various modifications and adaptations can be made without departing from the scope thereof.

1) A system for adapting a rotary internal combustion engine for direct drive marine vessel propulsion comprising:
at least one fuel delivery capability;
at least one air delivery capability;
at least one spark delivery capability;
at least one exhaust gas removal capability;
at least one power transmission capability;
at least one engine temperature regulation capability; and
at least one engine control capability for monitoring and regulating devices operatively associated with performance of said system;
wherein said system operates at peak power and torque at midrange engine speeds.

2) The system of claim 1, wherein said system includes at least one intake air compressor device selected from the group comprising:
at least one turbocharger; and
at least one supercharger;
Wherein said intake air compressor device acts to enhance power and torque characteristics of said system at midrange engine speeds.

3) The system of claim 2, wherein said turbocharger comprises a turbine housing operatively connected to a compressor housing by a common shaft.

4) The system of claim 3, wherein said turbine housing contains a turbine wheel, said common shaft, an exhaust air inlet, and an air outlet.

5) The system of claim 4, wherein said turbine wheel is a design that comprises at least 10 impeller blades.

6) The system of claim 3, wherein said compressor housing contains a compressor wheel, said common shaft, an intake air inlet, and an air outlet.

7) The system of claim 2, wherein said turbocharger housing contains passageways for flow of coolant for thermal management of turbocharger bearings, and impeller systems.

8) The system of claim 2, wherein said turbocharger housing contains a wastegate mounting orifice, wherein said orifice diameter is between 1.0 and 1.5 inches in diameter.

9) The system of claim 4, wherein said wastegate mounting orifice is positioned adjacent to an air intake flange on said housing, wherein the static pressure at the orifice position is minimal allowing high volume airflow from the exhaust side of the turbocharger out of the orifice.

10) The system of claim 2, wherein said system includes at least one intake air cooling device selected from the group comprising:
at least one intercooler assembly; and
at least one aftercooler assembly;
Wherein said intake air cooling device functions to increase air density thereby allowing increased air and fuel mixture to enter said rotary internal combustion engine resulting in enhanced combustion and power.

11) The system of claim 10, wherein said aftercooler assembly comprises a honeycomb pattern inner arrangement of tubing within a chamber, wherein cooling fluid is circulated inside said tubing and intake air is circulated through said chamber.

12) The system of claim 10, wherein said aftercooler assembly is constructed of stainless steel material.

13) The system of claim 11, wherein said cooling fluid is selected from a group comprising:
recirculated coolant from a closed cooling system; and
nonrecirculated coolant from an open cooling system.

14) The system of claim 10 wherein said aftercooler assembly supports an air volume flow rate of between 1000 and 2500 cfm.

15) The system of claim 14, wherein said air volume flow rate is 1.5 times larger than the air volume flow rate specified for a reciprocating piston internal combustion engine of equal cylinder displacement.

16) The system of claim 1, wherein said engine temperature regulation capability includes a closed recirculation system and an open non-recirculation system.

17) The system of claim 16, wherein said closed recirculation system comprises a fluid pump, a tandem cooler heat exchanger, a series of connectors and tubes to said rotary internal combustion engine, and coolant fluid wherein said coolant fluid cools the engine and said tandem cooler heat exchanger cools said coolant.

18) The system of claim 16, wherein said open non-recirculation system comprises a fluid pump, a series of connectors and tubes, and non-recirculated coolant, wherein said coolant passes through said turbocharger housing, said aftercooler chamber, said tandem cooler assembly, and a water jacketed exhaust manifold prior to being ejected away from said system.

19) The system of claim 18, wherein said tandem cooler assembly comprises a section for heat exchange between said non-recirculated coolant and said engine coolant, and a section for heat exchange between said non-recirculated coolant and engine oil.

20) The system of claim 18, wherein cooled exhaust passing through said water jacketed exhaust manifold passes through said turbocharger housing and combines with said non-recirculated coolant prior to being ejected away from said system.

21) The system of claim 20, wherein a backpressure is exerted on said exhaust as a result of mixing with said non-recirculated coolant and ejection into a fluid environment away from said system.

22) The system of claim 1, wherein the exhaust gas removal capability comprises said water jacketed exhaust manifold with an opening in said exhaust manifold whereby the exhaust side of said turbocharger housing is placed upon an opening positioned equidistant from the exhaust ports.
